(19) United States
(12) Patent Application Publication
(10) Pub. No.: US 2010/0276087 A1
(43) Pub. Date: Nov. 4, 2010

(54) ROTARY CLAMP MECHANISM FOR A FIBER PLACEMENT HEAD

(75) Inventors: Dennis L. Weinman, West Chester, OH (US); Ralph J. Rust, Chevoit, OH (US)

Correspondence Address: REISING ETHINGTON P.C., P O BOX 4390, TROY, MI, 48099-4390, US

(73) Assignee: CINCINNATI MACHINE, LLC, Hebron, KY (US)

(21) Appl. No.: 12/738,492

(22) PCT Filed: Oct. 15, 2008
(86) PCT No.: PCT/US08/79963

§ 371 Date: Jun. 30, 2010

Related U.S. Application Data
(60) Provisional application No. 60/980,201, filed on Oct. 16, 2007.

(51) Int. Cl. B29C 70/38

(52) U.S. Cl. 156/433

(57) ABSTRACT

A rotary clamp mechanism for a fiber placement head comprises a one-way bearing and a freewheeling roller mounted upstream of the restart mechanism. An actuating mechanism brings the freewheeling roller and the one-way bearing into contact with the fiber tow and allows the tow to be fed through the head from the upstream to the downstream end, but prevents the fiber tow from traveling in the reverse direction through the head. The rotary clamp is put into contact with the fiber tow prior to cutting the tow, and remains in contact with the tow until the restart mechanism has advanced the cut tow to the delivery end of the head. The rotary clamp eliminates the need for precise timing between the cutting and clamping mechanisms, and increases the application rate of fiber tow by the head.

### CROSS-REFERENCE TO RELATED APPLICATION

The instant application claims priority to U.S. Provisional Application Ser. No. 60/980,201 filed Oct. 16, 2007, the entire specification of which is expressly incorporated herein by reference

### FIELD

The apparatus relates to a mechanism for clamping tow after it has been cut in a fiber placement head against the reverse tension that is exerted on the tow.

### BACKGROUND

Fiber placement heads for laying tow onto an application surface are well known in the art. Fiber tow is supplied to the head from a creel that is located remote from the head. A movable arm is attached to the creel and the head is coupled to the end of the arm by a highly maneuverable wrist. In practice, a tension is maintained on the fiber tow between the creel and the head to prevent the formation of slack in the tow as the wrist changes the orientation of the head to follow the contour of the application surface. The tension is created by laying tow on the application surface with the compaction roller at a greater rate of speed than the speed at which the tow is supplied from the creel to the head. The tension on the tow will cause the tow to be withdrawn into the head when the tow breaks, or more commonly, when the tow is cut by a cutter mounted in the head at the end of a course. To prevent this, a clamp mechanism in the head is used to clamp the tow upstream of the cutter whenever the cutter cuts the tow.

The tow has to be cut at the end of each traverse of the fiber placement head across the application surface, or when it is desired to terminate the laying down of tow in a particular lane to the application surface. Cutting the tow presents a special set of problems. If the tow is cut while it is moving through the cutter, tow is cut on the fly. This produces a lengthened cut at the end of the tow and there are limits to how fast the tow can be moving when it is cut. If the tow is stopped for the cutting operation, the tow application rate becomes too slow for commercial considerations. Once the tow is cut, a clamp mechanism is used to hold the tow upstream of the cuter against the tension on the tow to prevent the tow from being pulled backward through the head.

Prior art clamp mechanisms comprise a pair of opposed clamp surfaces positioned above and below each tow lane. The clamp surfaces are normally spaced apart, allowing the tow to pass freely therebetween. When the tow in a particular lane needs to be cut, the cutter mechanism is actuated to cut the tow, and the clamp mechanism is actuated to clamp the tow against the tension on the tow that tends to retract the tow backward through the head. If the clamp mechanism is actuated too early, the compaction roller continues to pull the tow through the head as the clamp mechanism closes on the tow, causing a build up of resin on the clamp mechanism that requires frequent cleaning If the clamp mechanism is actuated too late, the cutter cuts the tow before the tow is clamped against the tension on the tow, and the tow can be snapped back into the head, leading to tow restart inaccuracies and in extreme cases, requiring that particular tow lane to be rethreaded. As a result, millisecond timing is required between the actuation of the cutter and clamp mechanisms in order for a cutting operation to be executed properly. In many cases, the application speed of the tow to the application surface is slowed down in anticipation of a cutting operation in order for the cutting and clamping operations to occur without fault. This unacceptably slows down the overall application rate of the tow to the application surface.

When tow feed in a particular lane is restarted, the timing is again critical. The restart rollers have to be restarted or reengaged with the tow just before the clamp mechanism that opposes the tension on the tow is opened. Engaging the restart rollers before releasing the clamp causes the clamp to scuff or break the tow. Engaging the restart rollers after the clamp is opened allows the tension in the tow to retract the tow back into the head.

It would accordingly be desirable to provide a mechanism for clamping the tow during the operation of either cutting the tow or restarting the tow that did not require the millisecond timing of prior art mechanisms.

It would also be desirable to decrease the lane-to-lane variability for the restarting and cutting of tows.

### BRIEF DESCRIPTION OF THE DRAWINGS

FIG. 1 is a perspective view of the interior of a fiber placement head.

FIG. 2 is a detail view of the cutter mechanism used in the fiber placement head of FIG. 1.

FIG. 3 is an enlarged view of the clamp and restart mechanisms of FIG. 1.

FIG. 4 is a timing diagram showing the control signals used to operate a fiber placement head.

### DESCRIPTION OF THE PREFERRED EMBODIMENT

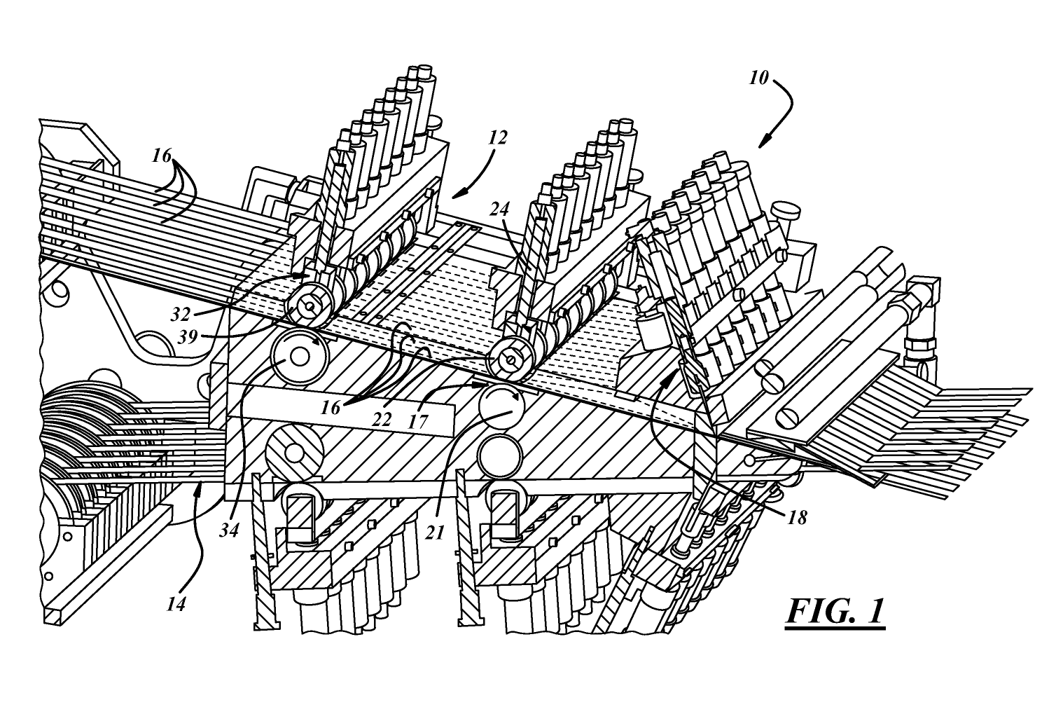

FIG. 1 is a perspective view of the interior 10 of a fiber placement head. A fiber placement head is used to apply fiber composite material to an application surface. In the example shown, the fiber placement head has sixteen upper tow lanes 12 and sixteen lower tow lanes 14. The fiber tow 16 travels through the head from the upstream end of the head shown on the left side of the drawing to the downstream end of the head shown on the right side of the drawing. The fiber tow 16 in the upper and lower lanes meet and interleave with one another at the compaction roller (not shown) at the downstream end of the head as well known in the art.

A restart roller assembly 17 and a cutter assembly 18 are provided for each tow lane. The restart roller assembly comprises a drive roll 21 and an opposed idler roll 22 upstream from the cutter assemblies 18. The drive rolls 21 in the upper lanes are driven to rotate clockwise, and are used to drive the tow 16 to the compaction roller. The idler rollers 22 are mounted on the ends of actuating rods 24, and may be extended into engagement with the opposed drive roll 21 and the tow 16 in the tow lane. When the drive from the restart roll assembly 17 is not required, the idler rollers 22 may be retracted out of engagement with the tow 16 in the respective tow lane. The restart roller assembly 17 pulls the tow 16 through the head and drives the tow to the compaction roller after the tow has been cut by the cutter 18. Once the fiber tow reaches the compaction roller and is being laid on the application surface, the restart roller assemblies 17 are no longer needed to drive the tow through the head, and are normally retraced from driving engagement with the tow, since the compaction roller pulls the tow through the head as it moves across the application surface.

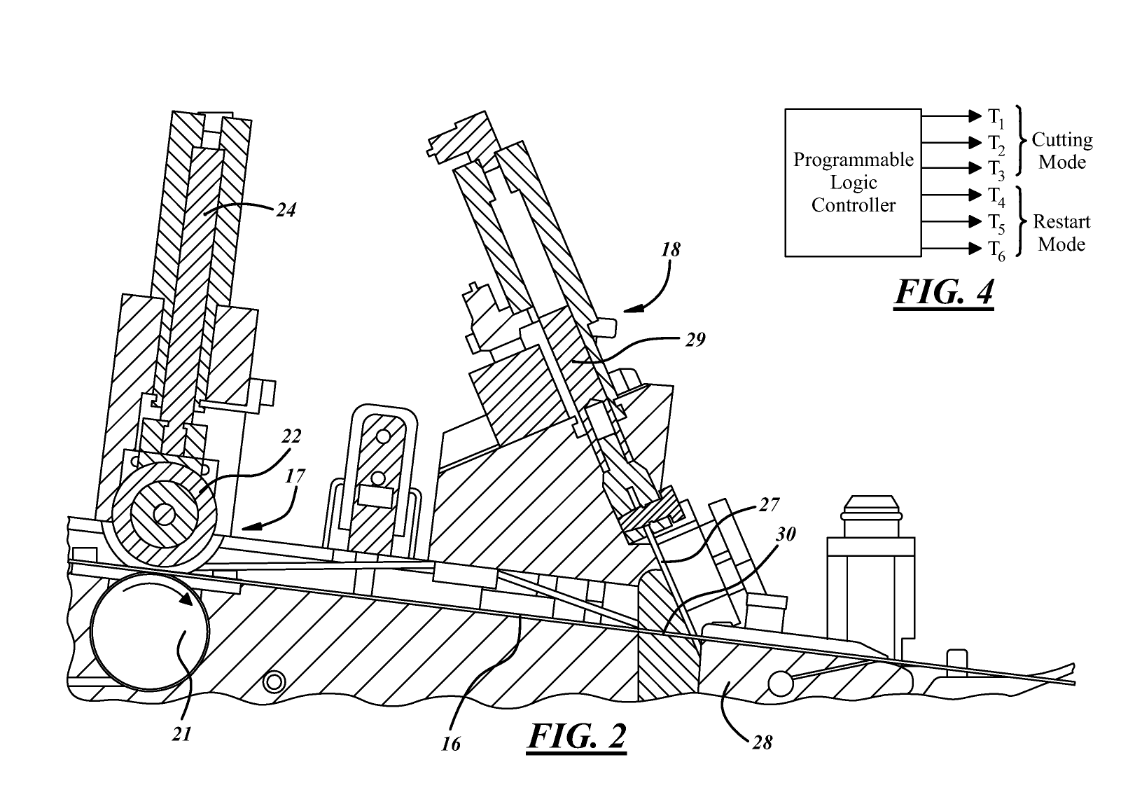

As best seen in FIG. 2 the cuter assembly 18 comprises a series of guillotine type cutters, one for each tow lane as well known in the art. Each cutter assembly comprises a knife blade 27 that is positioned above the tow lane 30, and an opposed anvil 28. The knife blade is mounted on the end of an actuating element 29, and the element may be energized to drive the blade toward the anvil, cutting the tow that is positioned on the tow lane 30.

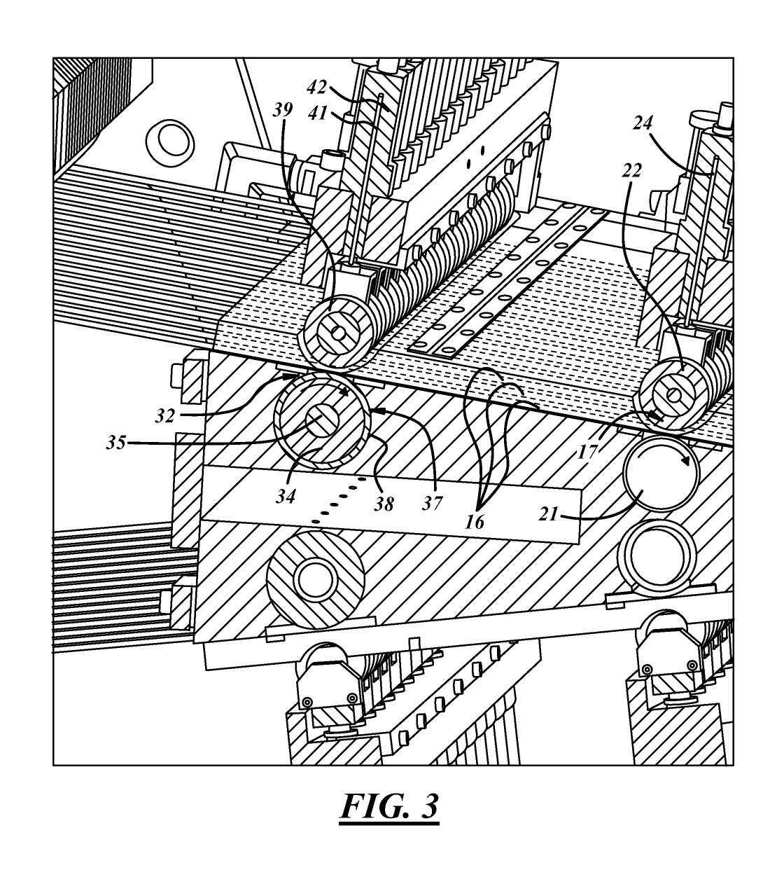

As shown on FIGS. 1 and 3 of the drawings, a rotary tow clamp mechanism 32 replaces the prior art clamp mechanism. The rotary tow clamp mechanism decreases the lane-to-lane variance of tow length caused by inconsistent timing of cutting and clamping the tow in the various lanes.

The rotary tow clamp mechanism 32 comprises a one-way bearing 34 mounted on a support shaft 35 for each tow lane. The one-way bearings rotate freely in one direction, but lock against rotation in the opposite direction. Such bearings are also called Sprague bearings. A sleeve 37 is mounted on the outer circumference of the bearing, and the outer surface of the sleeve is coated with an abrasive material 38. Opposing the one-way bearing on the opposite side of the tow lane is a freewheeling roller 39 mounted on the end of the actuating shaft 41 of a pneumatic cylinder 42. A separate one-way bearing 34 and an opposed freewheeling roller 39 are provided for each tow lane.

When the head is operating in the fiber application mode, the freewheeling roller 39 is retracted from contact with the tow 16 in the tow lane, and the tow passes freely between the freewheeling roller 39 and the sleeve 37 on the one-way bearing 34.

When tow in one of the lanes needs to be cut, a signal from the controller energizes the guillotine style cutter 27. Before the cutter 27 is extended, the actuating shaft 41 of the cylinder for the freewheeling roller 39 for that lane is extended into contact with the tow 16 in the lane. The one-way bearings 34 in the upper tow lanes 12 rotate freely in the clockwise direction to allow the tow 16 to be pulled by the compaction roller through the nip formed by the one-way bearing 34 and the roller 39 through the fiber placement head 10 and onto the application surface. The tow 16 continues to be fed through the head and the one-way bearings 34 in the upper lanes 12 continue to rotate clockwise until the cutter mechanism 18 cuts the tow. Once the tow 16 is cut, any reverse motion of the tow 16 in response to the tension on the tow is prevented by the one-way bearings 34 that by their design are unable to rotate in a counterclockwise direction. Moreover, the tow 16 is clamped between the abrasive surface 38 on one-way bearing 34 and the freewheeling roller 39, effectively locking the tow in place in the head.

The ability of the tow 16 to feed forward during application but to be locked against reverse tension on the tow eliminates the critical timing between the cutter and the clamp and minimizes the lane-to-lane cut length variation of the tows. In prior art systems, the tow can be scarred or torn if timing is not accurate. Because the rotary clamp mechanism 32 is more robust, the millisecond timing between the actuation of the cutter 18 and the clamp is no longer required, and cutting on the fly (while the tow is moving through the head) can take place with greater precision and at higher feedrates.

In the restarting mode, a signal from the control energizes the restart roller 22. The tow is already held in place by the rotary clamp 32 as a result of the cutting operation described above. The rotary clamp 32 remains energized after the tow is cut until the tow is restarted by the restart roll mechanism 17. The energized rotary clamp 32 prevents the tow 16 from being pulled back into the fiber head since the one-way bearing 34 can only rotate in the feed direction, but the tow is free to be fed forward once the restart roll mechanism is engaged. The action of the tow being fed forward but locked from pulling back eliminates the critical timing between the restart roller and the clamp and minimizes the lane-to-lane restart variation of the tows. In the prior art, if the clamp is not released before the restart roller begins to feed the tow, the surface of the tow material can be scuffed and a tear could result to produce a clog in the head. Because restarting with the rotary clamp is more robust, the precise millisecond timing accuracy of clamp and restart roller actuation is no longer required, and restarting on the fly, while the tow is moving through the head, can more accurately occur at higher feedrates.

As shown in FIG. 4, a standard controller such as a programmable logic controller 46 may be used to provide output signals to control the operation of the fiber placement head as described above. The following output signals are numbered to correspond to the order in which they occur.

In the Cutting Mode:

T1 extend rotary clamp idler roller 39

T2 extend cutter 27 (after cutting, tow is automatically clamped against retraction by the rotary clamp)

T3 retract cutter 27

In the Restart Mode:

T4 extend the restart roller 21 (tow is pulled through the one-way bearing of the rotary clamp to the compaction roller)

T5 retract the idler roller 39 of the rotary clamp

T6 retract the restart roller 21.

Having thus described the invention, various modifications and alterations will be apparent to those skilled in the art, which modifications and alterations are intended to be within the scope of the invention as defined by the appended claims.

1. A delivery system for fiber tow in a fiber placement head comprising:
at least one tow lane for directing tow material through the fiber placement head from an upstream end to a downstream end;
a cutter mechanism positioned along the tow lane;
a restart mechanism positioned along the tow lane upstream of the cutter mechanism;
a clamp mechanism having a drive roller and an idler roller positioned along the tow lane upstream of the restart mechanism for releasably clamping the fiber tow,
a one-way bearing mounted for rotation on a shaft and a free wheeling roller mounted opposite the one-way bearing comprising the clamp mechanism; and,
an actuating mechanism for bringing the one-way bearing and the freewheeling bearing into contact with the fiber tow, whereby the one-way bearing and the free wheeling roller may be moved toward one another to grip the fiber tow therebetween, and whereby the freewheeling roller and the one-way bearing may be moved away from one another so that the fiber tow passes freely therebetween, and wherein the one-way bearing is capable of rotation in only one direction and locks against rotation in the opposite direction, the one-way bearing rotating in the one direction to allow the passage of fiber tow from the upstream end to the downstream end of the fiber placement head, and locking against rotation in the opposite direction to prevent reverse movement of the fiber tow from the downstream to the upstream end of the fiber placement head.

2. The fiber delivery system of claim 1 further comprising:
a pneumatic cylinder and an actuating shaft comprising the actuating mechanism, the pneumatic cylinder and an actuating shaft cooperating to move the freewheeling roller against the tow in the tow lane and clamping the tow between the freewheeling roller and the outer surface of the one-way bearing.

3. The fiber delivery system of claim 2 further comprising:
a sleeve mounted on the outer surface of the one-way bearing; and,
an abrasive coating on the outer surface of the sleeve, the abrasive coating being in contact with the fiber tow to clamp the tow against the freewheeling roller.

4. The fiber delivery system of claim 3 that is used to cut, clamp and restart fiber tow as it is being applied to an application surface according to the following sequence:
at time T1 the freewheeling roller is extended toward the one-way bearing and into contact with the fiber tow;
at time T2 the cutter is extended to cut the fiber tow;
at time T3 the cutter is retracted, where T1 occurs before T2 and T2 occurs before T3, and wherein after the fiber tow is cut at time T2, the tow is automatically clamped against reverse motion through the fiber placement head by being gripped between the outer surface of the one-way bearing and the freewheeling roller.

5. The fiber delivery system of claim 4 that is used to restart fiber tow after it has been cut and clamped according to the following sequence:
at time T4 the idler roller of the restart mechanism is extended into contact with the fiber tow and the restart roller to pull the tow through the fiber placement head;
at time T5 the freewheeling roller is retracted away from the one-way bearing and from contact with the fiber tow; and,
at time T6 the idler roller is retracted from contact with the fiber tow, whereby between time T4 and T5 before the freewheeling roller is retracted from contact with the fiber tow the restart roller is able to pull the fiber tow through the fiber placement head because of the rotation of the one-way bearing.
